(19) United States
(12) Patent Application Publication
(10) Pub. No.: US 2024/0160737 A1
(43) Pub. Date: May 16, 2024

(54) METHODS AND APPARATUS DETERMINING DOCUMENT BEHAVIOR BASED ON THE REVERSING ENGINE

(71) Applicant: SECULETTER CO., LTD., Seongnam-si (KR)

(72) Inventor: Jun Ho CHOI, Suwon-si (KR)

(73) Assignee: SECULETTER CO., LTD., Seongnam-si (KR)

(21) Appl. No.: 17/780,736

(22) PCT Filed: May 26, 2022
(86) PCT No.: PCT/KR2022/007482

§ 371 Date: May 27, 2022

(51) Int. Cl. G06F 21/56; G06F 21/14

(52) U.S. Cl. CPC G06F 21/565; G06F 21/14

(57) ABSTRACT

This specification relates to a method of determining, by a server, a document action of an analysis target non-portable executable (non-PE) file. The method may include executing a process of an application program related to the analysis target non-PE file in a debugging mode, setting a first break point at a point matched with a document action, based on the process of the application program, executing the analysis target non-PE file, performing first monitoring on whether the process of the application program has been stopped at the first break point, and generating information on the document action of the analysis target non-PE file based on results of the first monitoring.

### TECHNICAL FIELD

This specification relates to a method and apparatus for determining a document action by debugging a non-portable executable (non-PE) file based on a reversing engine.

### BACKGROUND ART

In an advanced persistent threat (APT) attack, in order for an attacker to determine a specific target and steal targeted information, various types of malware are persistently used by applying a high-level attack scheme. In particular, an APT attack is not detected at an initial intrusion stage in many cases. A non-portable executable (non-PE) file including malware is chiefly used in the APT attack.

A document action is an action of a non-PE file to execute an action of a related application program. The existing APT solutions determine whether a non-PE file is malicious by monitoring a change in a sandbox (virtual machine (VM)) after an action of a document occurs because the APT solutions operate based on a document action. In this case, a long analysis time is required because whether the non-PE file is malicious is determined after a wait for the full revelation of the document action.

Furthermore, the existing APT solutions determine whether the non-PE file is malicious based on a change in the sandbox after executing the non-PE file in the sandbox. For example, the APT solution may confirm an approximate function of a document action through WINDOWS API hooking, but it is difficult for the APT solution to accurately know which action has been caused by using which function of the document because many functions are included in a common document process.

For example, the APT solution may know whether a document has executed a process, but cannot know whether the document has executed the process by using a specific function (e.g., DDE or Macro) of the document.

### DISCLOSURE

### Technical Problem

Various embodiments are directed to proposing a method and apparatus for determining which specific function of a document has a document action that is revealed through a non-PE file used.

Technical objects to be achieved by this specification are not limited to the aforementioned object, and the other objects not described above may be evidently understood from the following detailed description of the specification by a person having ordinary knowledge in the art to which this specification pertains.

### Technical Solution

In an embodiment, a method of determining, by a server, a document action of an analysis target non-portable executable (non-PE) file may include executing a process of an application program related to the analysis target non-PE file in a debugging mode, setting a first break point at a point matched with a document action, based on the process of the application program, executing the analysis target non-PE file, performing first monitoring on whether the process of the application program has been stopped at the first break point, and generating information on the document action of the analysis target non-PE file based on results of the first monitoring.

Furthermore, the method may further include determining whether a new module related to the analysis target non-PE file has been loaded, setting a second break point at a point matched with the document action, based on the loading of the new module, performing second monitoring on whether the process of the application program has been stopped at the second break point, and generating information on the document action of the analysis target non-PE file based on results of the second monitoring.

Furthermore, the method may further include inspecting whether a non-PE file is being executed. The executing of the analysis target non-PE file may be based on the non-PE file being not executed.

Furthermore, the method may further include determining whether the reading of the analysis target non-PE file has been terminated.

Furthermore, the method may further include transmitting the information on the document action to a terminal, based on the reading of the analysis target non-PE file having been terminated.

Furthermore, the setting of the first break point may be based on information on a preset point matched with the document action.

Furthermore, the determining of whether the reading of the analysis target non-PE file has been terminated may be based on a preset time.

In another embodiment, a server which determines a document action of an analysis target non-portable executable (non-PE) file may include a communication unit, a memory comprising a debugging engine, and a processor configured to functionally control the communication unit and the memory. The processor may execute a process of an application program related to the analysis target non-PE file by using a debugging engine, may set a first break point at a point matched with a document action, based on the process of the application program, may execute the analysis target non-PE file, may perform first monitoring on whether the process of the application program has been stopped at the first break point, and may generate information on the document action of the analysis target non-PE file based on results of the first monitoring.

### Advantageous Effects

According to an embodiment of this specification, which specific function of a document has a document action that is revealed through a non-PE file used can be determined by using the reversing engine.

Effects which may be obtained in this specification are not limited to the aforementioned effects, and other effects not described above may be evidently understood by a person having ordinary knowledge in the art to which this specification pertains from the following description.

### BRIEF DESCRIPTION OF DRAWINGS

FIG. 1 is a block diagram for describing an electronic device related to this specification.

FIG. 2 is a diagram illustrating a server or a client related to this specification.

FIG. 3 is an example of an abnormal input which may be applied to this specification.

FIG. 4 exemplifies a method of determining a document action to which this specification may be applied.

FIG. 5 is an example of an additional action of the server for obtaining a document action to which this specification may be applied.

FIG. 6 exemplifies a DDE function instruction detection table of the server to which this specification may be applied.

The accompany drawings, which are included as part of the detailed description in order to help understanding of this specification, provide embodiments of this specification and describe the technical characteristics of this specification along with the detailed description.

### MODE FOR INVENTION

Hereinafter, embodiments disclosed in this specification are described in detail with reference to the accompanying drawings. The same or similar element is assigned the same reference numeral regardless of its reference numeral, and a redundant description thereof is omitted. It is to be noted that the suffixes of elements used in the following description, such as a “module” and a “unit”, are assigned or interchangeable with each other by taking into consideration only the ease of writing this specification, but in themselves are not particularly given distinct meanings and roles. Furthermore, in describing an embodiment disclosed in this specification, when it is determined that a detailed description of a related known technology may obscure the subject matter of an embodiment disclosed in this specification, the detailed description will be omitted. Furthermore, it is to be understood that the accompanying drawings are merely intended to make easily understood the embodiments disclosed in this specification, and the technical spirit disclosed in this specification is not restricted by the accompanying drawings and includes all changes, equivalents, and substitutions which fall within the spirit and technical scope of this specification.

Terms including ordinal numbers, such as a “first” and a “second”, may be used to describe various elements, but the elements are not restricted by the terms. The terms are used to only distinguish one element from the other element.

When it is said that one element is “connected” or “coupled” to another element, it should be understood that one element may be directly connected or coupled to another element, but a third element may exist between the two elements. In contrast, when it is described that one element is “directly connected to” or “brought into direct contact with” the other element, it should be understood that a third element does not exist between the two elements.

An expression of the singular number includes an expression of the plural number unless clearly defined otherwise in the context.

In this specification, it is to be understood that a term, such as “include” or “have”, is intended to designate that a characteristic, a number, a step, an operation, an element, a part or a combination of them described in the specification is present, and does not exclude the presence or addition possibility of one or more other characteristics, numbers, steps, operations, elements, parts, or combinations of them in advance.

Furthermore, the term “ . . . unit” used in this specification means a software or hardware element, and the “ . . . unit” performs specific tasks. However, the term “ . . . unit” does not mean that it is limited to software or hardware. The “ . . . unit” may be configured to reside on an addressable storage medium and configured to operate one or more processors. Accordingly, examples of the “ . . . unit” may include elements, such as software elements, object-oriented software elements, class elements, and task elements, processes, functions, attributes, procedures, sub-routines, segments of a program code, drivers, firmware, a microcode, circuitry, data, a database, data structures, tables, arrays, and variables. The functionalities provided in the elements and the “ . . . units” may be combined into fewer elements and “ . . . units”, or may be further separated into additional elements and “ . . . units”.

Furthermore, “ . . . unit” according to an embodiment of this specification may be implemented as a processor and a memory. The term “processor” should be widely interpreted as including a general-purpose processor, a central processing device (CPU), a microprocessor, a digital signal processor (DSP), a controller, a microcontroller, a state machine, etc. In some environments, the “processor” may denote an application-specific semiconductor (ASIC), a programmable logic device (PLD), a field programmable gate array (FPGA), etc. The term “processor” may denote a combination of processing devices, such as a combination of a DSP and a microprocessor, a combination of a plurality of microprocessors, a combination of one or more microprocessors combined with a DSP core, or a combination of any other such elements.

The term “memory” should be widely interpreted as including any electronic component capable of storing electronic information. The term “memory” may denote various types of processor-readable media, such as random access memory (RAM), read-only memory (ROM), non-volatile random access memory (NVRAM), programmable read-only memory (PROM), erasable-programmable read-only memory (EPROM), electrically erasable PROM (EEPROM), flash memory, a magnetic or optical data storage device, and registers. If a processor can read information from memory and/or record information on the memory, the memory is said to be in the state in which the memory electronically communicates with the processor. The memory integrated on the processor may be in the electronic communication state with the processor.

The concept of a “non-PE file” used in this specification is opposite to the concept of a PE file or an executable file, and the “non-PE file” means a file that is not autonomously executed. For example, the non-PE file may be a document file such as a PDF file, a Hangul file, or a MS Word file, an image file such as a JPG file, a video file, a JavaScript file, or an HTML file, but the present disclosure is not limited thereto.

Hereinafter, embodiments are described in detail with reference to the accompanying drawings in order for a person having ordinary knowledge in the art to which this specification pertains to easily carry out the embodiments. Furthermore, in order to clearly describe the present disclosure, parts not related to the description may be omitted in the drawings.

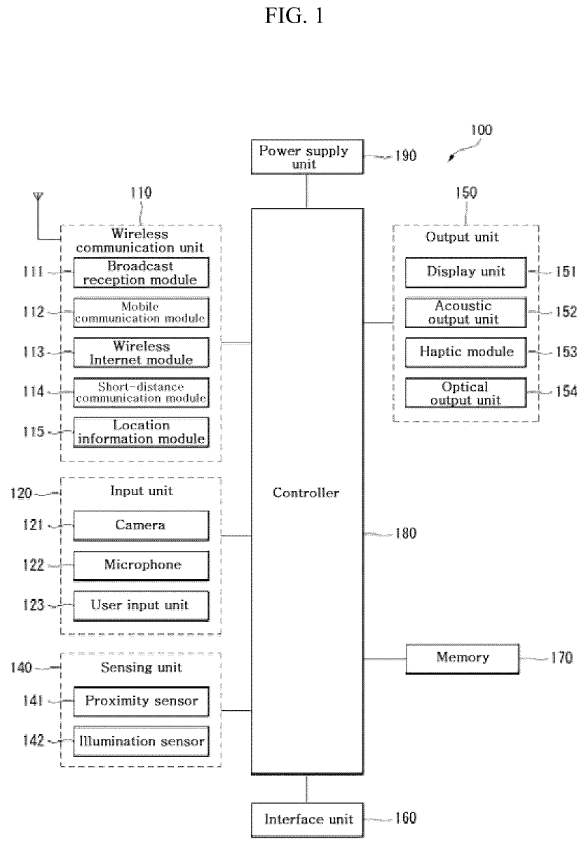

FIG. 1 is a block diagram for describing an electronic device related to this specification.

An electronic device 100 may include a wireless communication unit 110, an input unit 120, a sensing unit 140, an output unit 150, an interface unit 160, a memory 170, a controller 180, a power supply unit 190, etc. The elements illustrated in FIG. 1 are not essential for implementing the electronic device. The electronic device described in this specification may include more or less elements than the listed elements.

More specifically, among the elements, the wireless communication unit 110 may include one or more modules which enable wireless communication between the electronic device 100 and a wireless communication system, between the electronic device 100 and another electronic device 100, or between the electronic device 100 and an external server. Furthermore, the wireless communication unit 110 may include one or more modules that connect the electronic device 100 to one or more networks.

The wireless communication unit 110 may include at least one of a broadcast reception module 111, a mobile communication module 112, a wireless Internet module 113, a short-distance communication module 114, and a location information module 115.

The input unit 120 may include a camera 121 or an image input unit for receiving an image signal, a microphone 122 or an audio input unit for receiving an audio signal, and a user input unit 123 (e.g., a touch key or a mechanical key) for receiving information from a user. Voice data or image data collected by the input unit 120 may be analyzed and processed as a control command of a user.

The sensing unit 140 may include one or more sensors for sensing at least one of information within the electronic device, information about a surrounding environment that surrounds the electronic device, and user information. For example, the sensing unit 140 may include at least one of a proximity sensor 141, an illumination sensor 142, a touch sensor, an acceleration sensor, a magnetic sensor, a gravity (G)-sensor, a gyroscope sensor, a motion sensor, an RGB sensor, an infrared (IR) sensor, a finger scan sensor, an ultrasonic sensor, an optical sensor (e.g., the camera 121), the microphone 122, a battery gauge, an environment sensor (e.g., a barometer, a soil hygrometer, a thermometer, a radioactivity detection sensor, a heat detection sensor, or a gas detection sensor), a chemical sensor (e.g., an electronic nose, a healthcare sensor, or a bio recognition sensor). The electronic device disclosed in this specification may combine and use pieces of information sensed by at least two of the sensors.

The output unit 150 is for generating an output that is related to a visual sense, an auditory sense, or a tactile sense, and may include at least one of a display unit 151, an acoustic output unit 152, a haptic module 153, and an optical output unit 154. The display unit 151 may implement a touch screen by forming a mutual layer structure with a touch sensor or by being formed along with the touch sensor in an integrated way. The touch screen may function as the user input unit 123 that provides an input interface between the electronic device 100 and a user, and may also provide an output interface between the electronic device 100 and a user.

The interface unit 160 plays a role as a passage with various types of external devices that are connected to the electronic device 100. The interface unit 160 may include at least one of a wired/wireless headset port, an external charger port, a wired/wireless data port, a memory card port, a port that connects a device having an identification module, an audio input/output (I/O) port, a video I/O port, and an earphone port. The electronic device 100 may perform proper control that is related to an external device connected thereto, based on the external device being connected to the interface unit 160.

Furthermore, the memory 170 stores data that supports various functions of the electronic device 100. The memory 170 may store multiple application programs (or applications) that are driven in the electronic device 100, data for an operation of the electronic device 100, and instructions. At least some of such application programs may be downloaded from an external server through wireless communication. Furthermore, at least some of the application programs may be present in the electronic device 100 from the time of release for basic functions (e.g., incoming, outgoing, receiving messages, and outgoing functions) of the electronic device 100. The application program may be stored in the memory 170, may be installed in the electronic device 100, and may be driven to perform an operation (or function) of the electronic device by the controller 180.

The controller 180 commonly controls an overall operation of the electronic device 100 in addition to an operation related to the application program. The controller 180 may provide or process information or a function suitable for a user by processing a signal, data, or information that is input or output through the aforementioned elements or driving the application program stored in the memory 170.

Furthermore, the controller 180 may control at least some of the elements described with reference to FIG. 1 in order to drive the application program stored in the memory 170. Moreover, the controller 180 may combine and operate at least two of the elements included in the electronic device 100 for the driving of the application program.

The power supply unit 190 is supplied with external power and internal power and supplies power to each of the elements included in the electronic device 100, under the control of the controller 180. The power supply unit 190 includes a battery. The battery may be an embedded battery or a battery having a replaceable form.

At least some of the elements may cooperate with each other and operate in order to implement an operation, control, or a control method of the electronic device according to various embodiments that are described below. Furthermore, an operation, control, or a control method of the electronic device may be implemented in the electronic device by the driving of at least one application program stored in the memory 170.

In this specification, a server (or a cloud server) or a client may include the electronic device 100. The electronic device 100 may be collectively called a terminal.

The terminal may be connected to an external server (or a cloud server) or a client over a network, and may communicate therewith.

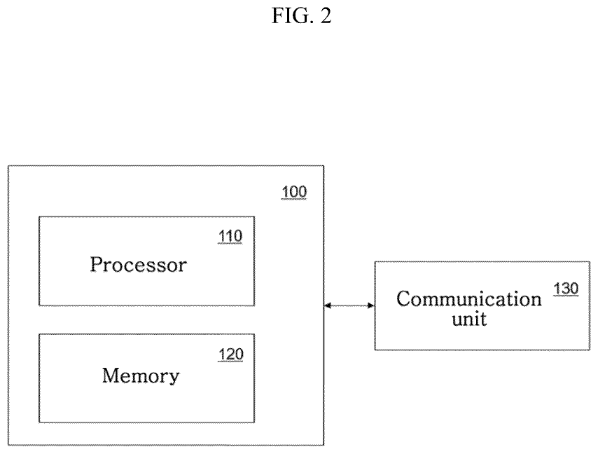

FIG. 2 is a diagram illustrating a server or a client related to this specification.

In this specification, the server (or a cloud server) or the client may include a controller 200 and a communication unit 230. The controller 200 may include a processor 210 and a memory 220. The processor 210 may perform instructions stored in the memory 220. The processor 210 may control the communication unit 230. The memory 220 may include a cache memory. The cache memory may temporarily store an original document to be described later for a given time.

The processor 210 may control an operation of the server or the client based on an instruction that is stored in the memory 220. The server or the client may include one processor, or may include a plurality of processors. If the server or the client includes a plurality of processors, at least some of the plurality of processors may be disposed at places that are physically spaced apart from each other. Furthermore, the server or the client is not limited thereto, and may be implemented by using various known methods.

The communication unit 230 may include one or more modules that enable wireless communication between the server or the client and a wireless communication system, between the server or the client and another server or client, or between the server or the client and an external server (or terminal). Furthermore, the communication unit 210 may include one or more modules that connect the server or the client to one or more networks.

The controller 200 may control at least some of the elements of the server or the client in order to drive an application program that is stored in the memory 220. Moreover, the controller 200 may combine and drive at least two of the elements that are included in the server or the client in order to drive the application program.

In this specification, the server may include a reversing engine or/and a contents disarm and reconstruction (CDR) engine that provides CDR services.

Reversing Engine

A reversing engine is an analysis/diagnosis engine obtained by automating a reverse engineering (reversing) process for a non-PE file. The reversing engine is called reverse engineering. A server may enter up to an assembly stage, that is, a language executable by a computer, with respect to software not having a source code through reverse engineering, and may know the principle and structure of the software. The server may know a common software (e.g., MS OFFICE or PDF) structure, a malware action, a method of abusing vulnerability, etc. by using the principle and structure of the software.

For example, the reversing engine may perform the following steps.
1. File analysis: this is a step of analyzing an appearance (e.g., properties, an author, a date created, or a file type) of a non-PE file itself. In this step, whether a non-PE file is malicious may be diagnosed based on only information of the non-PE file itself like a common vaccine program.
2. Static analysis: this is a step of determining whether a non-PE file is normal or malicious by extracting and analyzing data within the non-PE file. In this step, whether a non-PE file is malicious may be diagnosed by extracting internal data suitably for a file structure and comparing and analyzing the extracted data, without executing the non-PE file. This step may be suitable for a macro, the extraction and analysis of a URL, etc.
3. Dynamic analysis: this is a step of determining whether a non-PE file is malicious by analyzing an act of the non-PE file while executing and monitoring the non-PE file. If this step is used, a malicious act using a normal function, such as a macro, a hyperlink, or DDE, can be easily detected.
4. Debugging analysis: this is a step of analyzing vulnerability, exploits, etc. by executing and debugging a non-PE file. This step is suitable for detecting the vulnerability of an application program using a body, a table, a font, a picture, etc. within a document, including a macro, a hyperlink, or DDE.

The reversing engine may include a debugging engine which may be used in debugging analysis. The debugging engine can diagnose vulnerability which occurs in a document input, processing, and output stage by debugging a process of reading a non-PE file. In this case, the vulnerability relates to an error, a bug or the like, which occurs when an application program receives an unexpected value in a code (or logic) developed by a developer of the application program. An attacker may execute a malicious document act, such as the denial of service attributable to abnormal termination or the remote execution of a code, through the vulnerability.

A debugging engine may include a debugger. The debugger is a tool for reverse engineering, and may mean a program or process capable of another target program at an assembly level.

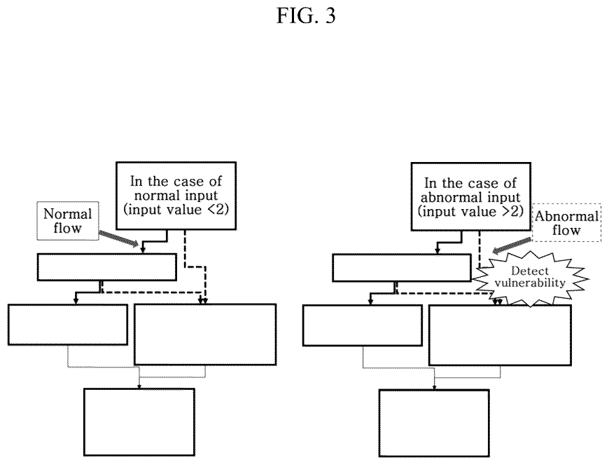

FIG. 3 is an example of an abnormal input which may be applied to this specification.

Referring to FIG. 3, when receiving an abnormal value (e.g., when an input value is greater than 2, that is, a normal range) through a non-PE file, an execution flow of an application program changes into an execution flow not intended by a developer, so that vulnerability may occur. The debugging engine may set a break point at a specific point that is related to the vulnerability by automatically debugging a document reading process, may check the specific value related to the input value, and may diagnose whether the non-PE file is malicious by determining whether the input value is a value that causes the vulnerability.

More specifically, the debugging engine may start debugging by checking the non-PE file and executing the application program for reading the non-PE file. When a module related to a document action is loaded in the process of reading the non-PE file, the debugging engine may check whether the corresponding module is an analysis target module, and may set the break point at a designated address when the corresponding module is an analysis target.

For example, a malicious non-PE file may have branch points at which an application program is terminated or a flow of the application program branches into a flow in which any malicious act does not occur when a version of the application program or a specific condition, such as an operating system environment, is not satisfied. The server may set a break point at a branch point that is previously analyzed by an analyst and that has such a possibility.

Furthermore, the server may set conditions on which the server may continue to execute the application program without terminating the application program or may induce a flow of the application program into a flow in which a malicious act may occur, in association with a corresponding branch point.

If a process of the application program is stopped at a corresponding break point during the process, the server may perform a step of detecting the occurrence of vulnerability through detection logic and then storing the results of the detection in an analysis report.

The automation reversing engine that is included in the server can diagnose and block a malicious non-PE file through a diagnosis algorithm researched and developed by an analyst, by analyzing the aforementioned steps while automatically performing the aforementioned steps.

Contents Disarm and Reconstruction (CDR)

A CDR service is a solution that generates a new file by decomposing a non-PE file, removing a malicious file or an unnecessary file from the non-PE file, and making content therein identical with the original as much as possible.

That is, CDR means a service that generates a safe document by disarming and reconstructing content within a document and that provides the safe document to a customer. A disarming target file may include all non-PE files (e.g., a MS Word, Excel, PowerPoint, a Hangul, and a PDF). Disarming target content may be active content (e.g., a macro, a hyperlink, and an OLE object).

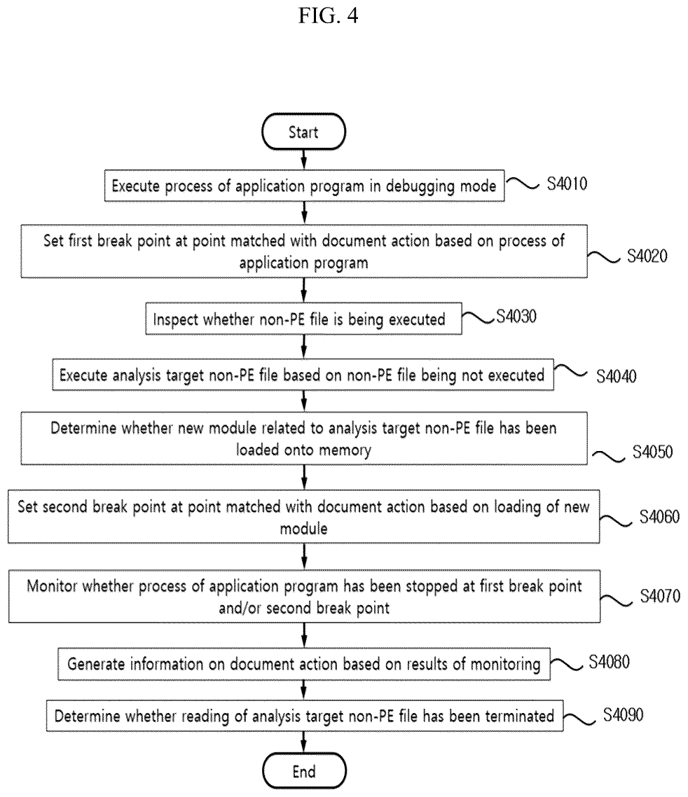

FIG. 4 exemplifies a method of determining a document action to which this specification may be applied.

Referring to FIG. 4, the server may include a non-PE file and an application program (e.g., MS Office or Hancom Office) for executing the non-PE file.

The server executes a process of the application program in a debugging mode (S4010). For example, the server may execute a document process for opening an analysis target non-PE file of the application program in the debugging mode (DEBUG_ONLY_THIS_PROCESS) by using a CreateProcess API. Accordingly, the server may receive a debug event of the process of the application program.

More specifically, the server may execute the process of the application program by assigning a flag “DEBUG_ONLY_THIS_PROCESS” to the process by using the CreateProcess API.

The server sets a first break point at a point that is matched with a document action, based on the process of the application program (S4020). For example, the server may set the break point by changing, into “0xCC”, an operation (OP) code related to the process of the application program that is loaded onto the memory. The OP code means a command code, and may be a code in which the contents of a task to be actually performed by a CPU are written. To this end, the server may change the memory by using WriteProcessMemory.

Information on a document action and a point matched with the document action may be previously set in the server. For example, the server may install a break point by using a WriteProcessMemory API based on an action matching break point table that has been previously defined.

The server inspects whether a non-PE file is being executed (S4030). More specifically, after setting the break point, the server checks whether other non-PE files of which analysis has been requested are being read. In an application process, a required module is loaded onto the memory based on a function that is required for the non-PE file. Accordingly, in terms of securing the reliability of a determination of a document action of a non-PE file, that is, a target, the application program needs to have a state in which other non-PE files have not been read. For example, if a malicious non-PE file has been read, the reliability of a result of a determination of a document action may be low.

The server executes the analysis target non-PE file based on the non-PE file being not executed (S4040). More specifically, the server reads the non-PE file of which analysis has been requested by a user by using a process (e.g., EXCEL, WORD, or PPT) of the application program, which is suitable for a corresponding format. For example, the server may read a sample.ppt file by using MS PowerPoint. Alternatively, the server does not inspect whether the non-PE file is being executed, but may directly execute the analysis target non-PE file.

The server determines whether a new module related to the analysis target non-PE file has been loaded onto the memory (S4050). When the analysis target non-PE file is executed by the process of the application program, the server checks whether the new module has been loaded onto the memory.

For example, when a debugging event occurs in the process of the application program, the server may receive the debugging event in the debugging mode. When a LOAD DLL event occurs, the server may determine the LOAD DLL event as a new module (e.g., mounted on a DLL memory) based on the debugging event. More specifically, when a “LOAD_DLL_DEBUG_EVENT” event occurs, the server may determine that a new module has been loaded onto the memory.

For example, the server may newly load, onto the memory, a module suitable for a process function of the application program in order to use a function (e.g., macro or an ActiveX function) that is necessary for the analysis target non-PE file.

The server sets a second break point at a point matched with a document action based on the loading of the new module (S4060). If it is determined that the new module has not been loaded onto the memory, the server does not set the second break point.

The server may monitor whether the process of the application program has been stopped at the first break point and/or the second break point (S4070). For example, the server may confirm whether the process of the application program has been stopped at the break point and the right to control the process has been taken over to the debugger. The debugger that has taken over the right to control the process may check at which break point the process has been stopped.

The server generates information on a document action that is matched with the first break point and/or the second break point, based on the results of the monitoring (S4080). For example, the server may check an address value of a break point. Thereafter, the server may generate information on the document action that is matched with the address value of the break point, based on information on the document action and a point matched with the document action, and may store the generated information.

Table 1 is an example of a stored address value of a break point and a document action matched with the address value.

TABLE 1

| Address of Break Point | Document Action |
|---|---|
| 0x12345678 | Execute ActiveX in a document |

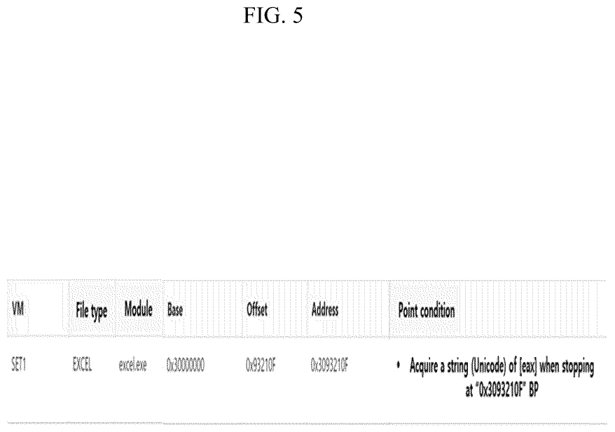

Furthermore, in order to obtain the document action, the server may perform an additional action. FIG. 5 is an example of an additional action of the server for obtaining a document action to which this specification may be applied.

Referring to FIG. 5, a “point condition” exemplifies an additional action of the server for obtaining a document action. For example, the server may detect a dynamic data exchange (DDE) document action of a non-PE file document through a break point. Furthermore, the server may know an instruction of a DDE function based on preset information (or table).

For example, the server may identify that the acquisition of a string has been automatically implemented on a code based on the preset information, and may know that a non-PE file will use which instruction by using the DDE function by extracting the code. Accordingly, the server may more accurately store a document action corresponding to a corresponding instruction.

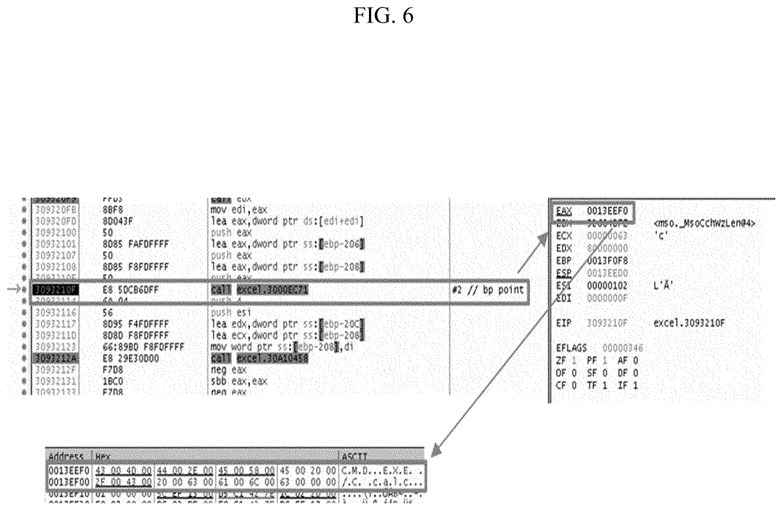

FIG. 6 exemplifies a DDE function instruction detection table of the server to which this specification may be applied.

Referring back to FIG. 4, the server determines whether the reading of the analysis target non-PE file has been terminated (S4090). For example, the server may determine whether the reading of the analysis target non-PE file has been terminated in a way, such as whether a preset time has elapsed, whether a message box (Alert) appears, or if a break point has not been passed for a given time.

If the reading of the analysis target non-PE file has not been terminated, the server persistently monitors whether the process of the application program has been stopped at the break point. Accordingly, the server may wait so that the document action is sufficiently revealed.

Thereafter, the server may transmit, to a terminal, the stored information on the document action. To this end, the terminal may communicate with the server, and may include a management program capable of controlling an operation of the server. The terminal may provide a user with the information on the document action through the management application program.

The existing APT solution extracts a document action based on a change in the sandbox after the document action is revealed. In this case, the time taken for analysis is long because the sandbox has to wait until the document action is revealed. Furthermore, an analysis speed for the document action is lower than that of this specification because the last part (e.g., after the sandbox is changed) is finally checked.

Furthermore, the server of this specification may start the analysis of a document action from timing at which a process of an application program is executed in a step prior to a change in the sandbox.

Furthermore, an analysis speed (action extraction) of a document action is higher than that of the existing APT solution because a change in the document action is checked from an assembly level (e.g., a CPU instruction processing step).

Furthermore, it is difficult for the existing APT solution to know end timing because the sandbox has to wait until the document action is revealed. However, in this specification, the server can rapidly analyze a document action because the server can approximately determine end timing of the document action.

Furthermore, in this specification, the server can accurately identify a function that is used by a process of an application program corresponding to a document action.

The aforementioned present disclosure may be implemented in a medium on which a program has been recorded as a computer-readable code. The computer-readable medium includes all types of recording devices in which data readable by a computer system is stored. Examples of the computer-readable medium include a hard disk drive (HDD), a solid state disk (SSD), a silicon disk drive (SDD), ROM, RAM, CD-ROM, a magnetic tape, a floppy disk, and an optical data storage device, and also include an implementation having the form of carrier waves (e.g., transmission through the Internet). Accordingly, the detailed description should not be construed as being limitative, but should be considered to be illustrative from all aspects. The scope of the present disclosure should be determined by reasonable analysis of the attached claims, and all changes within the equivalent scope of the present disclosure are included in the scope of the present disclosure.

Furthermore, although the services and embodiments have been chiefly described, they are only illustrative and are not intended to limit the present disclosure. A person having ordinary knowledge in the art to which the present disclosure pertains may understand that various modifications and applications not illustrated above are possible without departing from the essential characteristics of the present services and embodiments. For example, each of the elements described in the embodiments may be modified and implemented. Furthermore, differences related to such modifications and applications should be construed as belonging to the scope of the present disclosure defined in the appended claims.

1. A method of determining, by a server, a document action of an analysis target non-portable executable (non-PE) file, the method comprising:
executing a process of an application program related to the analysis target non-PE file in a debugging mode;
setting a first break point at a point matched with a document action, based on the process of the application program;
executing the analysis target non-PE file;
performing first monitoring on whether the process of the application program has been stopped at the first break point; and
generating information on the document action of the analysis target non-PE file based on results of the first monitoring.

2. The method of claim 1, further comprising:
determining whether a new module related to the analysis target non-PE file has been loaded;
setting a second break point at a point matched with the document action, based on the loading of the new module;
performing second monitoring on whether the process of the application program has been stopped at the second break point; and
generating information on the document action of the analysis target non-PE file based on results of the second monitoring.

3. The method of claim 2, further comprising inspecting whether a non-PE file is being executed,
wherein the executing of the analysis target non-PE file is based on the non-PE file being not executed.

4. The method of claim 1, further comprising determining whether a reading of the analysis target non-PE file has been terminated.

5. The method of claim 4, further comprising transmitting the information on the document action to a terminal, based on the reading of the analysis target non-PE file having been terminated.

6. The method of claim 1, wherein the setting of the first break point is based on information on a preset point matched with the document action.

7. The method of claim 4, wherein the determining of whether the reading of the analysis target non-PE file has been terminated is based on a preset time.

8. A server which determines a document action of an analysis target non-portable executable (non-PE) file, the server comprising:
a communication unit;
a memory comprising a debugging engine; and
a processor configured to functionally control the communication unit and the memory,
wherein the processor is configured to:
execute a process of an application program related to the analysis target non-PE file by using a debugging engine,
set a first break point at a point matched with a document action, based on the process of the application program,
execute the analysis target non-PE file,
perform first monitoring on whether the process of the application program has been stopped at the first break point, and
generate information on the document action of the analysis target non-PE file based on results of the first monitoring.
